(19) United States
(12) Patent Application Publication
(10) Pub. No.: US 2005/0010419 A1
(43) Pub. Date: Jan. 13, 2005

(54) System and Method for On-line Translation of documents and Advertisement

(76) Inventor: Ahmad Pourhamid, Reno, NV (US)

Correspondence Address: JEFFREY FURR, 253 N. MAIN STREET, JOHNSTOWN, OH, 43031, US

(21) Appl. No.: 10/604,254

(22) Filed: Jul. 7, 2003

(51) Int. Cl. G10L 11/00

(52) U.S. Cl. 704/277

(57) ABSTRACT

The invention is a system to provide a method to provide users with a site that offer both computer and human translations to translate documents and advertisement and allows users to offer advertisement in a plurality of language as set by the users. The system will give users an option of which of a plurality of languages that they want an advertisement in and how they want it translated.

### BACKGROUND OF INVENTION

1. Field of the Invention

This invention relates to the art of translation languages and more specifically, to the use of the Internet for this purpose and to have advertisements be available in multiple languages at a single location.

2. Description of Prior Art

The current means of translating documents and advertisements are very limited. There are really two main options; Human translations and computer translations.

Human translations are the more traditional and historic. I human being well versed in two or more language will take the document and translate it from one language to another. The problems with human translations are finding a good quality translator and the costs are this can be a time intensive process. Human error can be introduced.

Computer translations are relatively news. The computers use programs that are programmed to recognize words and phrases and translate them into one or more other languages. The issues with computer translations are access to the software and the inability of the computer programs to think.

The World Wide Web is currently a subject of intense and rapidly growing interest. The World Wide Web is composed of interconnected data sources that are accessible to computer users through data-communication networks such as the Internet. The data available on the World Wide Web has been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Most websites offer things for sale in a single language. E-bay, one of the world's largest on-line auction sites offers goods for sale in advertisement and listings that are in a single language. This limits the marketplace in today's global marketplace.

The need for a better method for a single site for translations and to offer advertisements in different language that is accurate, quick, inexpensive, and easy to use shows that there is still room for improvement within the art.

### SUMMARY OF INVENTION

The object of the present invention is to provide a method to provide users with a site that offer both computer and human translations to translate documents and advertisement and allows users to offer advertisement in a plurality of language as set by the users.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a Hyper-Text Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The process is more efficient, effective, accurate and functional than the current art.

GLOSSARY OF TERMS Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Logfile: a file residing on the Web site in which the Web server logs information about browsers requesting Web components. The logfile typically contains one line per hit.

Pageview: the event of a browser downloading some or all of the Web components that make up a Web page and displaying the Web page. A pageview often consists of several hits.

Referral page: the URL of the Web page containing the HyperText link that led a visitor to the data currently being viewed. In most commercial browsers, the BACK button returns the visitor to this referral page.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in ti me.

Visitor: a person operating a browser and, through it, visiting a Web site.

Web component: a basic data building block that makes up a Web page. A Web component may contain text, HyperText, images, embedded client software programs, or other data displayable by a browser (such as, for example, QuickTime videos).

Web designer: a person, typically one skilled in graphical design, who has charge of designing Web pages.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet.

FIG. 2 shows a sample of a system web page;

FIG. 3 displays a simple flowchart of the process; and

FIG. 4 displays multiple ads in multiple languages.

### DETAILED DESCRIPTION

The object of the present invention is to provide a method to provide users with a site that offer both computer and human translations to translate documents and advertisement and allows users to offer advertisement in a plurality of language as set by the users.

The System 1 is a leading global online network for advertising and translation services.

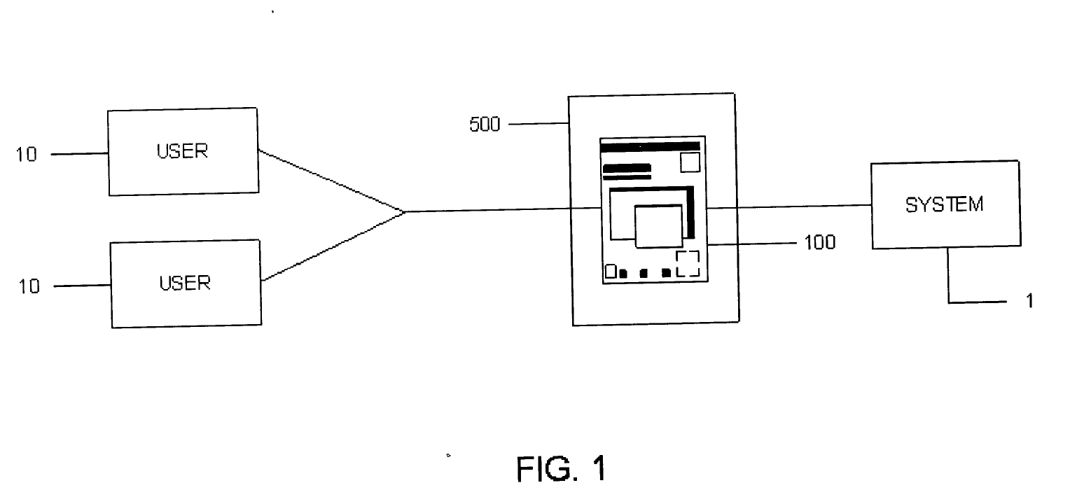

FIG. 1 illustrates a functional diagram of a computer network for World Wide Web 500 access to the system 1 from a plurality of Users 10 to the Web Site 100. Accessing the Web Site 100 can be accomplished directly through a communication means such as a local Internet Service Provider, often referred to as ISPs, or through an on-line service provider like CompuServe, Prodigy, American On-line, etc.

The Users 10 contact the System Web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98, XP or ME or Linus, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

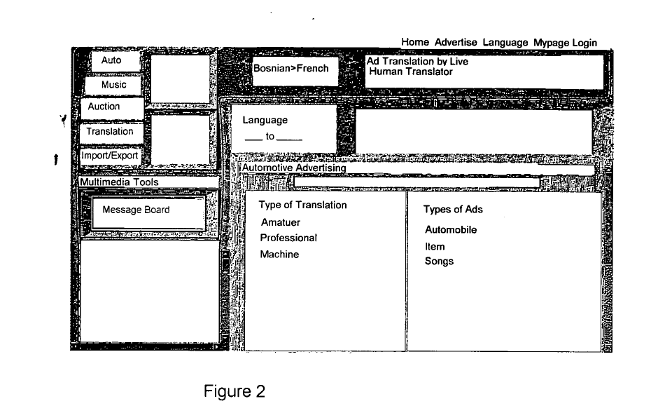

In one preferred embodiment of the invention, the Users 10 connect to the System Web Site 100. FIG. 2 displays the Web Site 100 sample main web page 200, which has several main key components. The Users 10 can select from a number of different types of advertisements and types of translations.

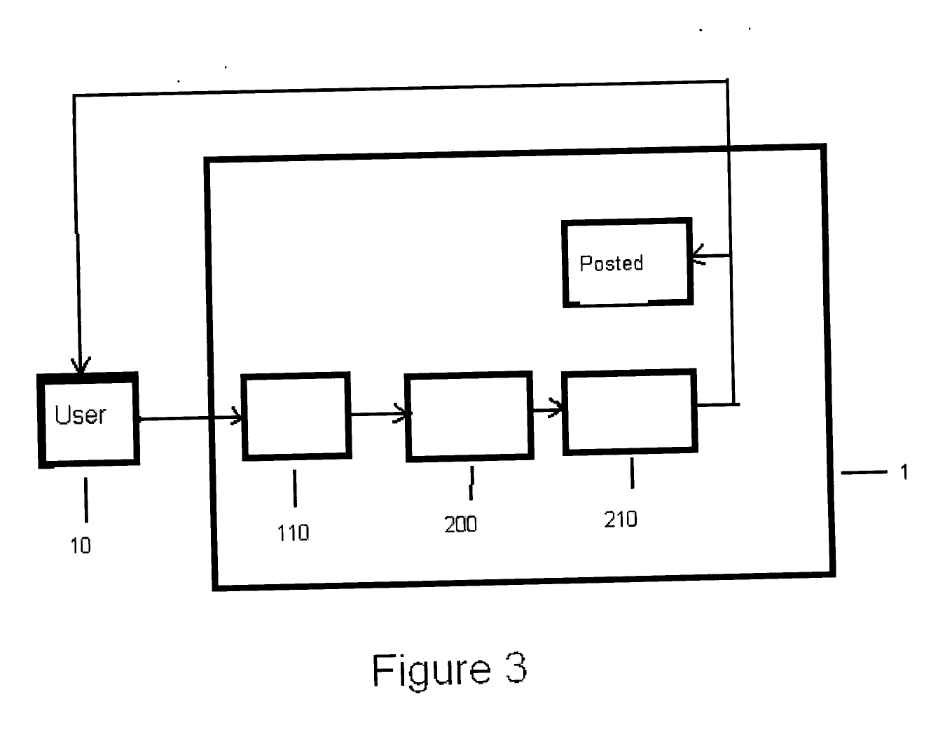

FIG. 3 displays a simplified flow chart of the system 1. The User 10 provides a document or an advertisement 110. The user 10 chooses the languages that they want the document 110 to be converted into, step 200. The user 10 then chooses the type of translation, step 210. The document 110 is either given back to the user 10 or posted on the web site 100.

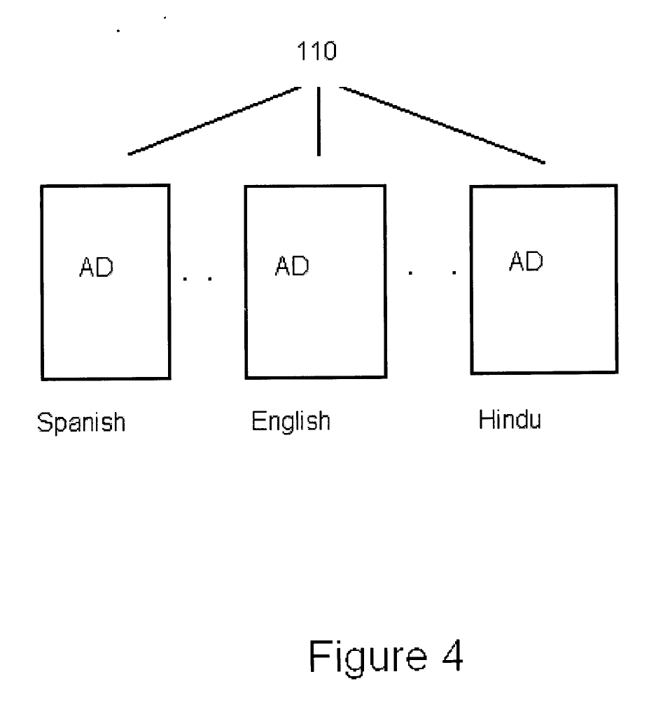

As shown in FIG. 4, the user 10 can have an advertisement 110 in several different languages. In the preferred embodiment the system 1 will offer several different types of advertising. These consist of: Auction style—in which the highest bidder after a set time wins the goods.

Buy it now style—which is an auction style advertisement with a fixed bid option at which a buyer can purchase the goods.

Standard asking price style—in which the user 10 sets the selling price.

Express advertising—which are Trade newsletter ads with other newsletters or banners or any web promotions services companiesExpress URL destination ads—which are advertisement with URL destinations.

Confidential standard advertising—which are standard advertisement with limited access.

Confidential sell advertising—which are standard sell advertisements with limited access.

Qualified visitors advertising—in which buyers must qualify for.

Voice advertising (voice files uploads by advertiser)—which are voice advertisements.

Video advertising (video files uploads by advertiser)—which are video advertisements.

Voice translation &presentation by translator to another language—which are voice advertisements.

Video translation &presentation by translator to another languagE which are video advertisements.

In the preferred embodiment the system 1 will offer different kinds of translation services. These consist of: Advertisement and Document Translation by computer software.

Advertisement translation by live humans who are amateur translators, which are at a lower rate.

Advertisement translation by live human professional translators, which are at a professional rate.

Advertisement translation by live human chosen translators, which allows a User 10 to choose a specify translatorAdvertisement translation by uploading to get bids by translators, which has the translators bidding on the cost of providing the services.

Documents translation by choosing the translator, which allows the user 10 to chose a specific translator for the translation.

Document translation by getting bid from translators, which allows the translators to bid for the services.

Voice translation services by translators, in which voice messages are translated.

Video translation and presentation by translators, in which video material is translated.

Email translation by translators, in which E-mails are translated and either returned to the User 10 or forwarded on to the E-mail precipitant.

Chat translation between buyers and sellers, in which a translator, either real person or a computer, provides translation between a plurality of people in a chat room or communicating real time.

Online interpreter translation services by online translators, which is real time translation for a real person or computer.

Notarization translators, which are translators who can give a notarization seal to the translation.

Proofreading translation, which are either a computer or real person translator who can double check a previously translation.

Interpreter translation, which is a real time translation service for those who need interpretation services.

The system 1 in the preferred embodiment is designed for as flexible communication methods as possible to offer the greatest access to the Users 10. In the preferred embodiment, the system 1 will offer phone communication, fax communication, standard email communication, chat communication, voice chat communication, video chat communication, voice email communication, video email communication, messenger communication, voice email communication, on line human communications, text message board communication, video message communication, Adobe PDF file uploading communication and live 3 way conferencing.

In the preferred embodiment, the system offers varies services to the User 10. These services include; free automobile samples to upload, product video uploading, product image uploading, Adobe PDF file uploading, HTML uploading, Double special category choice, Express links destinations ads, Bonus to buyers, allowing the User 10 to Re-list their ad as many times they want, allow the User 10 to chose to advertise as many weeks as you want, allows Users 10 to open a global internet store, Advertisements and documents can be translated to as many language as the User 10 decides, allow different categories for Users 10 to choose, to have a Users 10 rating option, allow a User 10 to view translator details, to have and allow Users 10 to view translator's rating, to have multiple engine software translation, to allow free email translation services by software, to have chat translation services by software, to have free voice chat rooms and to allow translations of messenger usage from any PC.

Operation

The web site 1 has offers several types of ad translations. The ads can be translated by several mechanisms. The main options are amateur translations, professional translations, or the user's choice of translator. The translation services include translation bids by individuals or institutes, online interpreter services, voice and video translation with translator's voice, and translation engines and tools. These services are all based on allowing a user or users to translate their ads for a fee. Types of ads supported are automotive advertising, lingo auction, unsigned music, import/export, and/or multimedia tools.

The multimedia tools includes audio and video advertising, talk global from PC to PC, send voice and voice email, audio or video message for buyers or sellers inside ads, chat and e-mail translation, global messenger, and/or global tools.

The import/export includes fixed or auction price in any language, present the product with voice or video, company data base, and/or sell to wholesaler small and large quantity.

Unsigned music includes music industry ads; multi lingual songs; upload/download; buy, sell and present; translate the songs; live scene; and/or free promotions.

Lingo auction includes fixed or auction price in any language, buy from importers, internet stores, unique categories, and/or find and communicate with marketer in other country.

Automotive advertising includes buy or sell, auto image samples, dealer to dealer, repair and services, part store, fixed or auction price, and/or confidential wholesale.

There are four types of ads included on this site. They are auction ads, standard ads, fixed price ads, and instant buy ads.

When Users 10 place an advertisment that includes translation by the human translator option in advertising webpage, the mechanism of the website will send a signal to the home page on top 3 window with trafic light green 80, as shown on FIG. 2, that means for translators who are on-line and let them know that a translation needed, they will find and pickup the advertisement or document 110 by clicking on it and translate it.

The system 1 is desinged to have a human live translator signal on its home page 100. This signal is used when an advertiser places anvertisement or document 110 and asks for human translation of the document 110. The system 1 will sendsignal to the home page and ask for translator. The translators will see the signal and will look for the document 110 to translate it.

The system 1 will have the capabililty for the User 10 to advertise and use an advertising page in other website link or use their website address or both.

The system 1 will have special categories that offer unique categories that are not offered by current art.

The user 10 can choose the language that they view the website 110 in. The language that the user 10 chooses the website 100 in does not effect the languages that advertisements 110 can be placed in.

Advantages

The current invention offers Global marketing communication in other languages and Global Pay by Result Marketing by removing language barriers. it allows the User 10 Free Global Marketing access, Global Email Marketing By Country, Global Targeted Email Marketing, Global Marketing By Publisher &Broadcast Agencies, Global Website Marketing, Global Domain Extension, Global Marketing Soft wares & Links, Global Hosting, Lingo Internet & Website, provides needed translation partners, Website Translation, Text & URL Translators, Browser Translators and Business Card Translation. The previously described version of the present invention has many advantages. The intent is to develop a better method for searching the Internet for specific information from a number of web sites that is accurate, quick, inexpensive, and easy to use, showing there is still room for improvement within the art.

Although the present invention has been described in considerable detail with reference to certain preferred versions thereof, other versions are possible. For example, the functionality and look of the web site could use different or new protocols or an Intranet could be used. Therefore, the point and scope of the appended claims should not be limited to the description of the preferred versions contained herein.

1. A system for translation on the Internet comprising:
a plurality of translation methods; and
for a plurality of languages.

2. The process according to claim 1 which includes the steps of having a user access the system through an Internet connection method.

3. The process according to claim 1 in which said translation methods include human translators and computer translation software.

4. The process according to claim 1 in which includes the steps of having real-time transaction.

5. The process according to claim 1 in which includes the steps of having a plurality of advertisements on the system web site.

6. The process according to claim 1 in which includes the steps of having an item translated.

7. The process according to claim 6 in which said item is a document.

8. The process according to claim 6 in which said item is a advertisement.

9. The process according to claim 6 in which said item is a video.

10. The process according to claim 6 in which said item is an audio message.

11. The process according to claim 6 in which said item is an E-mail.

12. The process according to claim 6 in which said item is an E-mail and said E-mail is forwarded to the recipient.

13. The process according to claim 6 in which said item is a chat room.

14. The process according to claim 1 which includes the step of having the system communicates to the user using a communication method.

15. The process according to claim 14 where said communication method is E-mail.

16. The process according to claim 14 where said communication method is the telephone.

17. The process according to claim 14 where said communication method is a chat room.

18. The process according to claim 14 where said communication method is a messenger system.

19. The process according to claim 1 which includes the step of having a ratings system for said translators.

20. The process according to claim 1 where said translation methods include professional and amateur translators.

21. The process according to claim 1 including the step of notifying the human translators when an item is available for translation.

22. The process according to claim 1 which includes the step of having the system point to another website.
